(19) United States
(12) Patent Application Publication
(10) Pub. No.: US 2011/0279358 A1
(43) Pub. Date: Nov. 17, 2011

(54) DISPLAY PANEL WITH REDUCED PARASITIC CAPACITANCE

(75) Inventors: Kye-Uk LEE, Pocheon-si (KR); Kee-Bum PARK, Cheonan-si (KR); Byoung-Sun NA, Hwaseong-si (KR)

(73) Assignee: SAMSUNG ELECTRONICS CO., LTD., Suwon-si (KR)

(21) Appl. No.: 12/903,463

(22) Filed: Oct. 13, 2010

(30) Foreign Application Priority Data
May 11, 2010 (KR) 10-2010-0043959

(51) Int. Cl. G09G 3/36

(52) U.S. Cl. 345/87

(57) ABSTRACT

An exemplary embodiment of a display panel according to the present invention includes; a substrate, a display area including a gate line disposed on the substrate, and a gate driver connected to one end of the gate line, the gate driver including a plurality of stages disposed in a first direction, and integrated on the substrate, wherein the gate driver includes; a plurality of clock signal lines extending in the first direction and a voltage signal line extending in the first direction, and the voltage signal line disposed between the plurality of clock signal lines and the plurality of stages.

This application claims priority to and Korean Patent Application No. 10-2010-0043959, filed on May 11, 2010, and all the benefits accruing therefrom under 35 U.S.C. §119, the content of which is incorporated herein in its entirety.

### BACKGROUND OF THE INVENTION

(a) Field of the Invention

A display panel is provided.

(b) Description of the Related Art

Among the various types of display panels, a liquid crystal display (“LCD”) is one type of flat panel display that is currently being widely used. The typical LCD includes two display panels in which field generating electrodes such as a pixel electrode and a common electrode, etc., are respectively formed, and a liquid crystal (“LC”) layer disposed therebetween. The LCD displays images by applying voltages to the field-generating electrodes to generate an electric field in the LC layer that determines the orientations of LC molecules therein to adjust polarization of incident light passing therethrough. Alternative display panels include organic light emitting devices, plasma display devices, electrophoretic displays, and various other display types in addition to the liquid crystal display.

Regardless which type of display device is used, the display device also includes a gate driver and a data driver for providing image formation signals to the display device. Among them, the gate driver may typically be integrated on the panel while being patterned together with a gate line, a data line, a thin film transistor (“TFT”), etc., which are used in forming an image. Since the integrated gate driver does not require an additional gate driving chip, it is possible to save manufacturing cost through its use.

### BRIEF SUMMARY OF THE INVENTION

The exemplary embodiments of the present invention reduce resistor-capacitor (“RC”) delay.

The exemplary embodiments of the present invention reduce deteriorations in manufacturing quality due to static electricity.

The present invention may be used to achieve the above objects and other objects that are not specifically described.

An exemplary embodiment of a display panel according to the present invention includes; a substrate, a display area including a gate line disposed on the substrate, and a gate driver connected to one end of the gate line, the gate driver including a plurality of stages disposed in a first direction, and integrated on the substrate. The gate driver includes a plurality of clock signal lines extending in the first direction and a voltage signal line extending in the first direction, and the voltage signal line is disposed between the plurality of clock signal lines and the plurality of stages.

In one exemplary embodiment, the plurality of clock signal lines may include at least four clock signals.

In one exemplary embodiment, the plurality of clock signal lines and the voltage signal line may be positioned a same distance from the substrate.

In one exemplary embodiment, the voltage signal line may further include an assistance signal line extending in the first direction outside the plurality of clock signal lines, and the assistance signal line is connected to the voltage signal line.

In one exemplary embodiment, the voltage signal line may include a branch signal line connected to the voltage input terminal of the stage.

In one exemplary embodiment, the branch signal line may be disposed at a different distance from the substrate than the plurality of clock signal lines and the voltage signal line.

In one exemplary embodiment, two of the plurality of clock signal lines may be respectively connected to a first clock input terminal of the stage and a second clock input terminal of the stage.

In one exemplary embodiment, the stage may include a first input terminal, a second input terminal, an output terminal, and a transmitting signal output terminal, and the first input terminal of at least one of the plurality of stages may be connected to the transmitting signal output terminal of the other stage, and the output terminal may be connected to the second input terminal of the other stage.

In one exemplary embodiment, the stage may include an input unit, a pull-up driver, a pull-down driver, an output unit, and a transmitting signal generator.

In one exemplary embodiment, the input unit, the pull-down driver, the output unit, and the transmitting signal generator may be connected to the first node.

An exemplary embodiment of a display panel according to the present invention includes; a substrate, a display area including a gate line, and a gate driver connected to one end of the gate line and including a plurality of stages integrated on the substrate. The gate driver includes a first voltage signal line which applies a first low voltage to a stage and a second voltage signal line which applies a second low voltage that is less than the first low voltage to a stage of the plurality of stages, the first voltage signal line is disposed between the plurality of stages and the display area, and the first voltage signal line is connected to one of the plurality of stages.

In one exemplary embodiment, the stage connected to the first voltage signal line may be a dummy stage.

In one exemplary embodiment, the first voltage signal line may be connected to a first metal pattern, and the first voltage signal line and the first metal pattern may be disposed at the same distance from the substrate.

In one exemplary embodiment, the first voltage signal line may be connected to the first metal pattern through the connecting member, and the connecting member may be disposed at a different distance from the substrate than the first voltage signal line.

In one exemplary embodiment, the stage may be applied with a clock signal, at least one transmitting signal of the previous stages, and at least two transmitting signals of the next stages, and may output a gate voltage having the first low voltage as a gate-off voltage.

In one exemplary embodiment, the second low voltage may be a voltage when the transmitting signal is low.

The exemplary embodiments according to the present invention may reduce RC delay, and may prevent deterioration in display manufacturing quality due to static electricity.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a top plan view of an exemplary embodiment of a display panel according to the present invention;

FIG. 2 is a block diagram showing an exemplary embodiment of a gate driver and a gate line in the exemplary embodiment of a display panel shown in FIG. 1;

FIG. 3 is a top plan view showing a region A of FIG. 2;

FIG. 4 is a cross-sectional view taken along line IV-IV of FIG. 3;

FIG. 5 is a circuit diagram showing an exemplary embodiment of one stage shown in FIG. 2;

FIG. 6 is a block diagram of an exemplary embodiment of a gate driver and a gate line of another exemplary embodiment of a display panel according to the present invention;

FIG. 7 is a block diagram of an exemplary embodiment of a gate driver and a gate line of another exemplary embodiment of a display panel according to the present invention;

FIG. 8 is a block diagram of an exemplary embodiment of a gate driver and a gate line of another exemplary embodiment of a display panel according to the present invention;

FIG. 9 is a top plan view of another exemplary embodiment of a display panel according to the present invention;

FIG. 10 is a block diagram showing an exemplary embodiment of a gate driver and a gate line in the exemplary embodiment of a display panel shown in FIG. 9;

FIG. 11 is a circuit diagram showing an exemplary embodiment of one stage shown in FIG. 10;

FIG. 12 is a top plan view showing exemplary embodiments of a dummy stage and the first stage of the exemplary embodiment of a gate driver shown in FIG. 9;

FIG. 13 is a cross-sectional view taken along line XIII-XIII of FIG. 12; and

FIG. 14 is a cross-sectional view taken along line XIV-XIV of FIG. 12.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements' as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be described in detail with reference to the accompanying drawings.

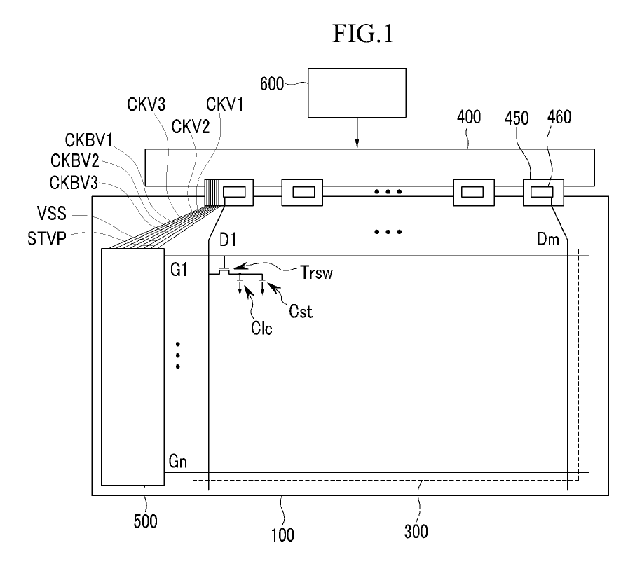

Now, an exemplary embodiment of a display panel according to the present invention will be described with reference to FIG. 1 to FIG. 5.

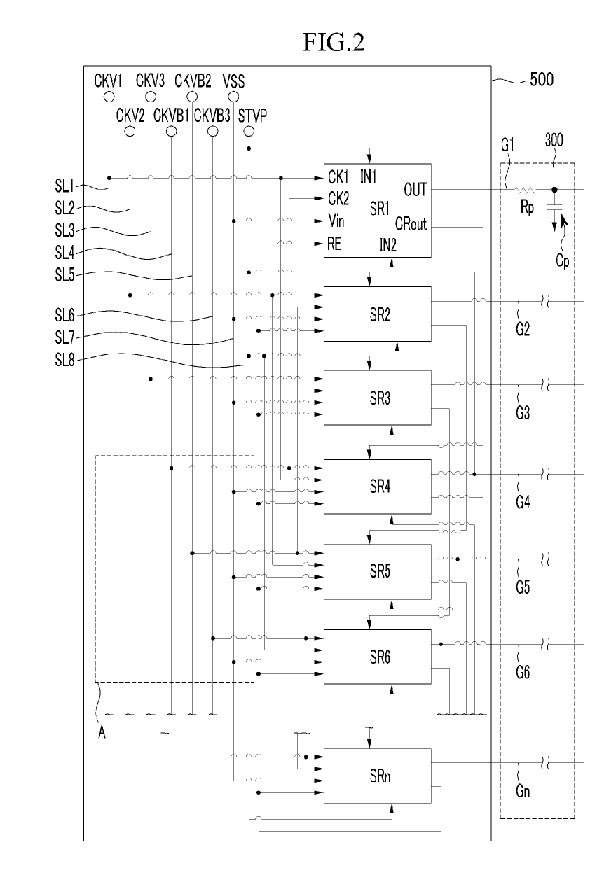

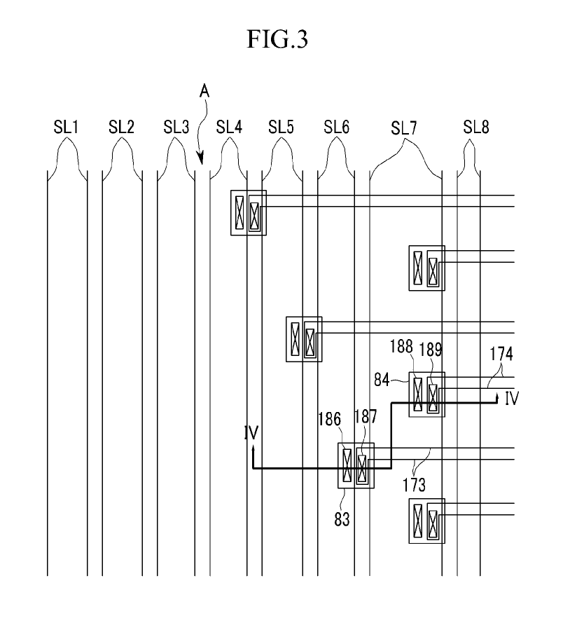

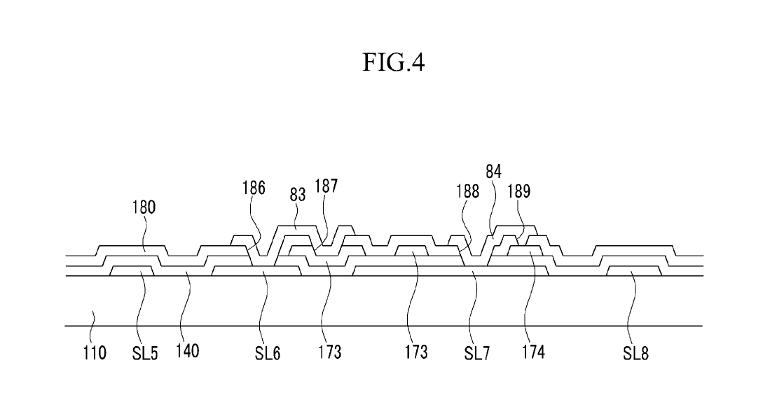

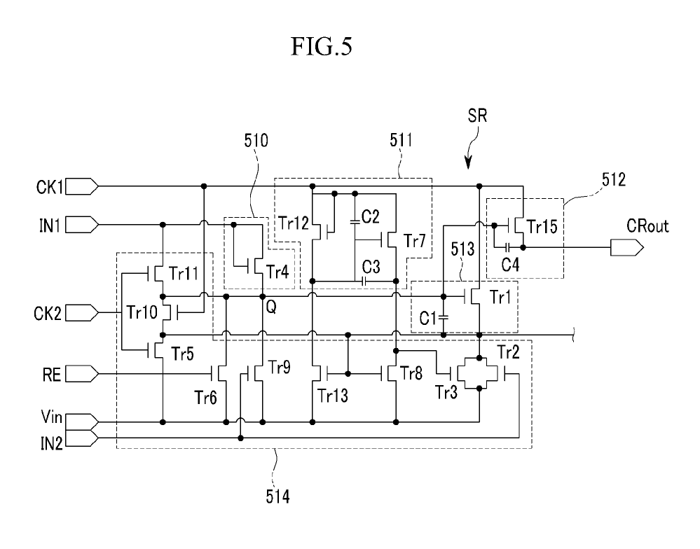

FIG. 1 is a top plan view of an exemplary embodiment of a display panel according to the present invention, FIG. 2 is a block diagram showing an exemplary embodiment of a gate driver and a gate line in the exemplary embodiment of a display panel shown in FIG. 1, FIG. 3 is a top plan view showing a region A of FIG. 2, FIG. 4 is a cross-sectional view taken along line IV-IV of FIG. 3, and FIG. 5 is a circuit diagram showing an exemplary embodiment of one stage shown in FIG. 2.

Referring to FIG. 1, a display panel 100 includes a display area 300 on which images are displayed and a gate driver 500 applying a gate voltage to gate lines G1-Gn of the display area 300. Data lines D1-Dm of the display area 300 receive a data voltage from a data driver integrated circuit (“IC”) 460 formed on a flexible printed circuit (“FPC”) film 450 attached to the display panel 100. The gate driver 500 and the data driver IC 460 are controlled by a signal controller 600. A printed circuit board (“PCB”) 400 is formed outside the FPC film 450 thereby transmitting signals from the signal controller 600 to the data driver IC 460 and the gate driver 500. The signals provided from the signal controller 600 include clock signals, e.g., clock signals CKV1, CKV2, CKV3, CKVB1, CKVB2, and CKVB3, a scan start signal STVP, and a special voltage Vss.

In the present exemplary embodiment wherein the display is a liquid crystal display (“LCD”), the display area 300 includes a thin film transistor (“TFT”) Trsw, a liquid crystal capacitor Clc, and a storage capacitor Cst. However, in alternative embodiments wherein the display is not an LCD, e.g., when the display is an organic light emitting panel, the display includes a TFT and an organic light emitting diode, and other display panels such as a plasma display panel or an electro-phoretic display panel include an element such as a TFT. The TFT and associated circuitry thereby form the display area 300. Hereafter, an example of an LCD will be described, though one of ordinary skill in the art would appreciate that the present invention may be applied to a wide variety of different display devices.

The display area 300 includes a plurality of gate lines G1-Gn and a plurality of data lines D1-Dm, and the plurality of gate lines G1-Gn and the plurality of data lines D1-Dm are insulated from and intersect each other; that is, they cross one another without electrically contacting one another, e.g., in one exemplary embodiment they are disposed substantially perpendicular to each other.

Each pixel PX includes the TFT Trsw, the liquid crystal capacitor Clc, and the storage capacitor Cst. Alternative exemplary embodiments include configurations wherein the storage capacitor Cst may be omitted. The TFT Trsw includes a control terminal connected to one gate line, an input terminal connected to one data line, and an output terminal connected to one terminal of the liquid crystal capacitor Clc and one terminal of the storage capacitor Cst. The other terminal of the liquid crystal capacitor Clc is connected to a common electrode, and the other terminal of the storage capacitor Cst receives a storage voltage applied from the signal controller 600.

The plurality of data lines D1-Dm receive the data voltage from the data driver IC 460, and the plurality of gate lines G1-Gn receive the gate voltage from the gate driver 500.

The data driver IC 460 is positioned on an upper side of the display panel 100 and is connected to the data lines D1-Dm extending in the longitudinal direction. Also, the data driver IC 460 may be positioned on a lower side of the display panel 100.

The gate driver 500 receives the clock signals CKV and CKVB, the scan start signal STVP, and a low voltage Vss approximating a gate-off voltage to generate a gate voltage (which in the present exemplary embodiment includes a gate-on voltage and a gate-off voltage), and to sequentially apply the gate-on voltage to the gate lines G1-Gn.

The clock signals CKV1, CKV2, CKV3, CKVB1, CKVB2, and CKVB3, the scan start signal STVP, and the voltage Vss approximating the gate-off voltage that are applied to the gate driver 500 are applied to the gate driver 500 through the FPC film 450 positioned outside the display area 300, as shown in FIG. 1. These signals are transmitted from an external device or the signal controller 600 to the FPC film 450 through the printed circuit board PCB 400. Alternative exemplary embodiments also include configurations wherein there may be four or eight clock signals.

Referring to FIG. 2, the gate driver 500 includes a plurality of stages SR1-SRn that are dependently connected to each other. A plurality of clock signal lines SL1-SL6 are applied with the clock signals CKV1, CKV2, CKV3, CKVB1, CKVB2, and CKVB3, the voltage signal line SL7 is applied with the voltage Vss, and the scan start signal line SL8 is applied with the scan start signal STVP. The various signal lines SL1-SL8 extend in the column direction, respectively, and are approximately parallel to each other. In one exemplary embodiment, there may be four or more clock signals, and for example, in one exemplary embodiment there may be four or eight thereof. Also, the clock signal lines SL1-SL6, the voltage signal line SL7, and the scan start signal line SL8 are sequentially disposed adjacent to the stages SR1-SRn. For example, the voltage signal line SL7 is disposed between the clock signal lines SL1-SL6 and the stages SR1-SRn. The voltage signal line SL7 includes a branch signal line disposed extending approximately in the row direction, and the voltage Vss is applied to the voltage input terminal Vin of the stage SR1-SRn through the branch signal line. The branch signal line of the voltage signal line SL7 does not intersect the clock signal lines SL1-SL6 such that the branch signal line of the voltage signal line SL7 and the clock signal lines SL1-SL6 do not overlap each other, and thereby parasitic capacitance of the clock signal lines SL1-SL6 may be reduced and the resistor-capacitor (“RC”) delay may be reduced. For example, in the structure of FIG. 2, the capacitance of the clock signal line may be about 1762 pF, the resistance may be about 129.4 ohms, and the RC delay may be about 0.228 sec.

On the other hand, if the clock signal lines SL1-SL6 are disposed between the voltage signal line SL7 and the stage SR1-SRn, when the voltage Vss is applied to the stages SR1-SRn through the voltage signal line SL7, the voltage signal line SL7 and the clock signal lines SL1-SL6 are insulated from, and disposed intersecting, each other. That is, they cross one another without electrically contacting one another, e.g., in one exemplary embodiment they are disposed substantially perpendicular to each other. Accordingly, an overlapping region between the voltage signal line SL7 and the clock signal lines SL1-SL6 exists, and the capacitance of the clock signal lines SL1-SL6 increases, and the RC delay increases. For example, the capacitance of the clock signal line may be about 2152 pF, the resistance may be about 129.4 ohm, and the RC delay may be about 0.279 sec.

Each of the stages SR1-SRn includes two input terminals IN1 and IN2, two clock input terminals CK1 and CK2, a voltage input terminal Vin receiving the low voltage Vss corresponding to the gate-off voltage, a reset terminal RE, an output terminal OUT, and a transmitting signal output terminal CRout.

Firstly, the first input terminal IN1 is connected to the transmitting signal output terminal CRout of the previous stage thereby receiving the transmitting signal of the previous stage. For example, the first input terminal IN1 of the 4-th stage SR4 is connected to the transmitting signal output terminal CRout of the first stage SR1, the first input terminal IN1 of the 5-th stage SR5 is connected to the transmitting signal output terminal CRout of the second stage SR2, and the first input terminal IN1 of the 6-th stage SR6 is connected to the transmitting signal output terminal CRout of the third stage SR3. However, the first stage SR1, the second stage SR2, and the third stage SR3 respectively receive the scan start signal STVP through the first input terminal IN1. Also, the transmitting signal output terminal CRout of a final stage SRn is connected to the reset terminal RE of each stage SR1-SRn.

The second input terminal IN2 is connected to the output terminal OUT of a subsequent stage, thereby receiving the gate voltage of the subsequent stage. For example, the second input terminal IN2 of the first stage SR1 is connected to the output terminal OUT of the fourth stage SR4, the second input terminal IN2 of the second stage SR2 is connected to the output terminal OUT of the fifth stage SR5, and the second input terminal IN2 of the third stage SR3 is connected to the output terminal OUT of the sixth stage SR6. Where the n-th stage SRn does not have a subsequent stage from which to receive a signal, the scan start signal STVP may be applied thereto through the second input terminal IN2.

The clock signal lines SL1-SL6 are sequentially connected to the first clock terminal CK1 from the first stage SR1 to the sixth stage SR6, and are again sequentially connected to them from the seventh stage SR7 to the twelfth stage SR12, and this connection relationship is repeated.

Also, the second clock terminal CK2 of the stage SR1-SRn is applied with a clock signal that has a different phase from a clock signal applied to the first clock terminal CK1. For example, the second clock terminal CK2 of the first stage SR1 is applied with a clock signal CKVB1 having a different phase from the clock signal CKV1 which is applied to the first clock terminal CK1 of the first stage SR1, the second clock terminal CK2 of the second stage SR2 is applied with a clock signal CKVB2 having a different phase from the clock signal CKV2 which is applied to the first clock terminal CK1 of the second stage SR2, the second clock terminal CK2 of the third stage SR3 is applied with a clock signal CKVB3 having a different phase from the clock signal CKV3 which is applied to the first clock terminal CK1 of the third stage SR3, the second clock terminal CK2 of the fourth stage SR4 is applied with a clock signal CKV1 having a different phase from the clock signal CKVB1 which is applied to the first clock terminal CK1 of the fourth stage, the second clock terminal CK2 of the fifth stage SR5 is applied with a clock signal CKV2 having a different phase from the clock signal CKVB2 which is applied to the first clock terminal CK1 of the fifth stage, and the second clock terminal CK2 of the sixth stage SR6 is applied with a clock signal CKV3 having a different phase from the clock signal CKVB3 which is applied to the first clock terminal CK1 of the sixth stage.

The operation of the gate driver 500 will be described in greater detail below.

Firstly, the first stage SR1 receives the clock signals CKV1 and CKVB1 that are externally provided through the first clock input terminal CK1 and the second clock input terminal CK2, the scan start signal STVP through the first input terminal IN1, the low voltage Vss corresponding to the gate-off voltage through the voltage input terminal Vin, and the gate voltage (the voltage output from the OUT terminal) provided from the fourth stage SR4 through the second input terminal IN2, and outputs the gate voltage to the first gate line G1 through the output terminal OUT and outputs the transmitting signal CR from the transmitting signal output terminal CRout to transmit it to the first input terminal IN1 of the fourth stage SR4.

The second stage SR2 receives the clock signals CKV2 and CKVB2 that are externally provided through the first clock input terminal CK1 and the second clock input terminal CK2, the scan start signal STVP through the first input terminal IN1, the low voltage Vss corresponding to the gate-off voltage through the voltage input terminal Vin, and the gate voltage provided from the fifth stage SR5 through the second input terminal IN2, and outputs the gate voltage to the second gate line G2 through the output terminal OUT and outputs the transmitting signal CR from the transmitting signal output terminal CRout to transmit it to the first input terminal IN1 of the fifth stage SR5.

The third stage SR3 receives the clock signals CKV3 and CKVB3 that are externally provided through the first clock input terminal CK1 and the second clock input terminal CK2, the scan start signal STVP through the first input terminal IN1, the low voltage Vss corresponding to the gate-off voltage through the voltage input terminal Vin, and the gate voltage provided from the sixth stage SR6 through the second input terminal IN2, and outputs the gate voltage to the third gate line G3 through the output terminal OUT and outputs the transmitting signal CR from the transmitting signal output terminal CRout to transmit it to the first input terminal IN1 of the sixth stage SR6.

The fourth stage SR4 receives the clock signals CKVB1 and CKV1 externally provided through the first and second clock input terminals CK1 and CK2, the transmitting signal CR of the first stage SR1 through the first input terminal IN1, the voltage Vss corresponding to the gate-off voltage through the voltage input terminal Vin, and the gate voltage provided from the seventh stage SR7 through the second input terminal IN2, and outputs the gate voltage of the fourth gate line G4 through the output terminal OUT and outputs the transmitting signal CR from the transmitting signal output terminal CRout to transmit it to the first input terminal IN7 of the seventh stage SR7.

The fifth stage SR5 receives the clock signals CKVB2 and CKV2 externally provided through the first and second clock input terminals CK1 and CK2, the transmitting signal CR of the second stage SR2 through the first input terminal IN1, the voltage Vss corresponding to the gate-off voltage through the voltage input terminal Vin, and the gate voltage provided from the eighth stage SR8 through the second input terminal IN2, and outputs the gate voltage of the fifth gate line G5 through the output terminal OUT and outputs the transmitting signal CR from the transmitting signal output terminal CRout to transmit it to the first input terminal IN8 of the eighth stage SR8.

The sixth stage SR6 receives the clock signals CKVB3 and CKV3 externally provided from the first and second clock input terminals CK1 and CK2, the transmitting signal CR of the third stage SR3 through the first input terminal IN1, the voltage Vss corresponding to the gate-off voltage through the voltage input terminal Vin, and the gate voltage provided from the ninth stage SR9 through the second input terminal IN2, and outputs the gate voltage of the sixth gate line G6 through the output terminal OUT and outputs the transmitting signal CR from the transmitting signal output terminal CRout to transmit it to the first input terminal IN7 of the ninth stage SR9.

As described above, the connection relationship and the operation of the stage SR1-SRn may be repeated as a unit of three or multiples of three, such as a three-unit or a six-unit configuration as described above.

Next, the region A of FIG. 2 will be described with reference to FIG. 3 and FIG. 4.

Referring to FIG. 3 and FIG. 4, clock signal lines SL1-SL6, a voltage signal line SL7, and a scan start signal line SL8 are positioned on a substrate 110. In one exemplary embodiment the substrate may be made of a material such as glass, plastic or other material with similar characteristics. The clock signal lines SL1-SL6, the voltage signal line SL7, and the scan start signal line SL8 extend approximately in the column direction and are approximately parallel to each other. The voltage signal line SL7 is disposed between the clock signal lines SL1-SL6 and the scan start signal line SL8, and the stages SR1-SRn are disposed on the right side of the scan start signal line SL8 as illustrated. The clock signal lines SL1-SL6, the voltage signal line SL7, and the scan start signal line SL8 may be disposed within the same layer as the gate lines G1-Gn, and may be formed from substantially the same material, e.g., a gate metal layer which is patterned to form the gate lines G1-Gn and the clock signal lines SL1-SL6, the voltage signal line SL7 and the scan start line SL8. That is, the gate lines G1-Gn, the clock signal lines SL1-SL6, the voltage signal line SL7 and the scan start line SL8 may all be disposed a same distance from the substrate.

A gate insulating layer 140 is positioned on the clock signal lines SL1-SL6, the voltage signal line SL7, and the scan start signal line SL8. In one exemplary embodiment, the gate insulating layer 140 may include SiNx, SiOx, or other materials with similar characteristics. The gate insulating layer 140 has contact holes 186 and 188 exposing the clock signal lines SL1-SL6 or the voltage signal line SL7.

Branch signal lines 173 and 174 are formed on the gate insulating layer 140. The branch signal lines 173 and 174 extend approximately in the row direction, and are approximately parallel to each other. The branch signal lines 173 and 174 are connected to the clock signal lines SL1-SL6 or the voltage signal line SL7. The branch signal lines 173 and 174 may be disposed within the same layer as the data lines D1-Dm, and may be formed from substantially the same material, e.g., a data metal layer which is patterned to form the data lines D1-Dm and the branch signal lines 173 and 174. That is, the data lines D1-Dm and the branch signal lines 173 and 174 may all be disposed a same distance from the substrate.

A passivation layer 180 is formed on the branch signal lines 173 and 174. In one exemplary embodiment, the passivation layer 180 may include SiNx, SiOx, an organic insulating material or other material with similar characteristics. The passivation layer 180 has contact holes 187 and 189 exposing the branch signal lines 173 and 174.

Connecting members 83 and 84 are formed on the passivation layer 180. The connecting member 83 connects the clock signal lines SL1-SL6 and the branch signal line 173 through the contact holes 186 and 187. The connecting member 84 connects the voltage signal line SL7 and the branch signal line 174 through the contact holes 188 and 189. In one exemplary embodiment, the connecting members 83 and 84 may include indium tin oxide (“ITO”), indium zinc oxide (“IZO”) and other materials with similar characteristics.

The branch signal line 173 connected to the clock signal lines SL1-SL6 is electrically connected to the first clock terminal CK1 of each of the stages SR1-SRn. Also, the branch signal line 174 connected to the voltage signal line SL7 is electrically connected to the voltage input terminal Vin of each of the stages SR1-SRn.

Next, an exemplary embodiment of a structure of one stage SR will be described with reference to FIG. 5.

Referring to FIG. 5, each stage SR of the exemplary embodiment of a gate driver 500 includes an input unit 510, a pull-up driver 511, a transmitting signal generator 512, an output unit 513, and a pull-down driver 514.

The input unit 510 includes one transistor (a fourth transistor Tr4), the input terminal and the control terminal of the fourth transistor Tr4 are commonly diode-connected to the first input terminal IN1, and the output terminal is connected to a node Q (hereinafter referred to as “the first node”). The input unit 510 transmits the high voltage to the node Q when the high voltage is applied to the first input terminal IN1.

The pull-up driver 511 includes two seventh transistors Tr7, a twelfth transistor Tr12, two second capacitors C2, and a third capacitor C3. Firstly, the control electrode and the input electrode of the twelfth transistor Tr12 are commonly connected thereby receiving the clock signals CKV1, CKV2, CKV3, CKVB1, CKVB2, and CKVB3 through the first clock terminal CK1, and the output electrode thereof is connected to the pull-down driver 514. Also, the input electrode of the seventh transistor Tr7 receives the clock signals CKV1, CKV2, CKV3, CKVB1, CKVB2, and CKVB3 through the first clock terminal CK1, and the control terminal and the output terminal are connected to the pull-down driver 514. Here, the second capacitor C2 is connected between the input electrode and the control electrode of the seventh transistor Tr7, and the third capacitor C3 is connected between the control electrode and the output electrode of the seventh transistor Tr7.

The transmitting signal generator 512 includes one transistor (a fifteenth transistor Tr15) and one capacitor (a fourth capacitor C4). The input electrode of the fifteenth transistor Tr15 is input with the clock signals CKV1, CKV2, CKV3, CKVB1, CKVB2, and CKVB3 through the first clock terminal CK1, and the control electrode is connected to the output of the input unit 510, that is, the node Q. The control electrode and the output electrode of the fifteenth transistor Tr15 are connected by the fourth capacitor C4. The transmitting signal generator 512 outputs the transmitting signal CR according to the voltage of the node Q and the clock signals CKV1, CKV2, CKV3, CKVB1, CKVB2, and CKVB3.

The output unit 513 includes one transistor (a first transistor Tr1) and one capacitor (a first capacitor C1). The control electrode of the first transistor Tr1 is connected to the node Q, and the input electrode receives the clock signals CKV1, CKV2, CKV3, CKVB1, CKVB2, and CKVB3 through the first clock terminal CK1. The control electrode and the output electrode of the first transistor Tr1 are connected to the first capacitor C1, and the output terminal is connected to the gate lines G1-Gn. The output unit 513 outputs the gate voltage according to the voltage of the node Q and the clock signals CKV1, CKV2, CKV3, CKVB1, CKVB2, and CKVB3.

The pull-down driver 514 causes the gate-off voltage to be smoothly output by removing a charge that exists in the stage SR which may otherwise function to reduce the potential of the node Q and the voltage output to the gate line. In the present exemplary embodiment, the pull-down driver 514 includes nine transistors (a second transistor Tr2, a third transistor Tr3, a fifth transistor Tr5, a sixth transistor Tr6, an eighth transistor Tr8 to an eleventh transistor Tr11, and a thirteenth transistor Tr13).

Firstly, the fifth transistor Tr5, the tenth transistor Tr10, and the eleventh transistor Tr11 are coupled in series between the first input terminal IN1 input with the transmitting signal CR of the previous stage SR and the voltage input terminal Vin applied with the low voltage Vss conforming to the gate-off voltage. The control terminal of the fifth and eleventh transistors Tr5 and Tr11 receive the clock signals CKV1, CKV2, CKV3, CKVB1, CKVB2, and CKVB3 through the second clock terminal CK2, and the control terminal of the tenth transistor Tr10 receives the clock signals CKV1, CKV2, CKV3, CKVB1, CKVB2, and CKVB3 through the first clock terminal CK1. Here, the clock signals CKV1, CKV2, CKV3, CKVB1, CKVB2, and CKVB3 that are input to the first clock terminal CK1 and the second clock terminal CK2 have different phases from one another. Also, the node Q is connected between the eleventh transistor Tr11 and the tenth transistor Tr10, and the output terminal of the first transistor Tr1 of the output unit 513 is connected between the tenth transistor Tr10 and the fifth transistor Tr5, that is, the gate lines G1-Gn.

A pair of transistors Tr6 and Tr9 are coupled in parallel between the node Q and the low voltage Vss. The control terminal of the sixth transistor Tr6 receives the transmitting signal CR of a dummy stage through the reset terminal RE, and the control terminal of the ninth transistor Tr9 is input with the gate voltage of the subsequent stage through the second input terminal IN2.

The pair of transistors Tr8 and Tr13 are respectively connected between the outputs of two transistors Tr7 and Tr12 of the pull-up driver 511 and the low potential level Vss. The control terminal of the eighth and thirteenth transistors Tr8 and Tr13 are connected to the output terminal of the first transistor Tr1 of the output unit 513, that is, one of the gate lines G1-Gn.

Finally, the pair of transistors Tr2 and Tr3 are coupled in parallel between the output of the output unit 513 and the low potential level Vss. The control terminal of the third transistor Tr3 is connected to the output terminal of the seventh transistor Tr7 of the pull-up driver 511, and the control terminal of the second transistor Tr2 is input with the gate voltage of the subsequent stage through the second input terminal IN2.

If the gate voltage of the subsequent stage is input through the second input terminal IN2, the pull-down driver 514 changes the voltage of the node Q into the low voltage Vss through the ninth transistor Tr9, and the voltage output to the gate line through the second transistor Tr2 into the low voltage Vss. Also, if the transmitting signal CR of the dummy stage is applied through the reset terminal RE, the voltage of the node Q is again changed into the low voltage Vss through the sixth transistor Tr6. In an operation wherein the second clock terminal CK2 is applied with the high voltage, e.g., wherein the voltage having the different phase from the voltage applied to the first clock terminal CK1 is in a high state, the voltage output to the gate lines G1-Gn through the fifth transistor Tr5 is changed into the low voltage Vss.

In one exemplary embodiment, the transistors Tr1-Tr13 and, Tr15 formed in the stage SR may be NMOS transistors.

The gate voltage output from the stage SR is transmitted through one of the gate lines G1-Gn. The gate lines G1-Gn may be represented in a circuit view to have a resistance Rp and a capacitance Cp. These values are a representative value for an entire gate line, and may be changed according to the structure and the characteristics of the display area 300.

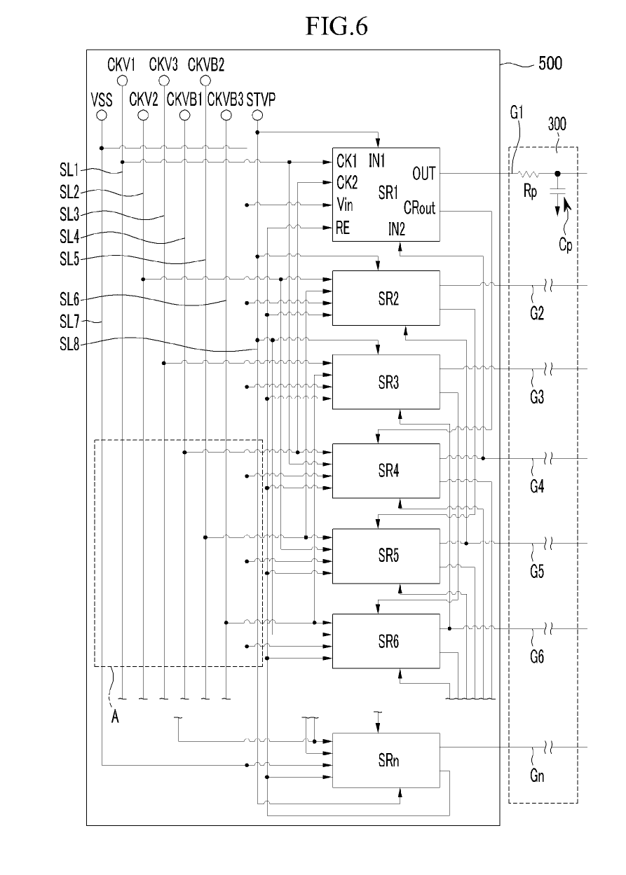

Next, a gate driver and a gate line of another embodiment of a display panel according to the present invention will be described with reference to FIG. 6. The repetitive description between the present disclosure and that of FIG. 1 to FIG. 5 is omitted.

FIG. 6 is a block diagram of an exemplary embodiment of a gate driver and a gate line of another exemplary embodiment of a display panel according to the present invention.

The voltage signal line SL7 forms an approximately rectangular shape, and includes two lines extending in the approximate column direction and two lines extending in the approximate row direction. In the present exemplary embodiment, the line disposed on the upper side among two lines extending in the row direction may be omitted. Two lines extending in the column direction are disposed between the clock signal lines SL1-SL6 and the scan start signal line SL8, and outside the clock signal lines SL1-SL6.

Similar to the exemplary embodiment described with respect to FIG. 2, the branch signal line connected to the voltage input terminal Vin of each of the stages SR1-SRn extends in the approximately row direction, and are directly connected to the voltage signal line SL7 positioned between the clock signal lines SL1-SL6 and the scan start signal line SL8. Accordingly, the branch signal line of the voltage signal line SL7 does not overlap the clock signal lines SL1-SL6 such that there is no overlapping between the branch signal line of the voltage signal line SL7 and the clock signal lines SL1-SL6, and thereby the parasitic capacitance of the clock signal lines SL1-SL6 may be reduced and the corresponding RC delay may be reduced. For example, in the structure of FIG. 6, the capacitance of the clock signal line may be about 1762 pF, the resistance may be about 129.4 ohm, and the RC delay may be about 0.228 sec.

The connection relationship of the stages SR1-SRn, the clock signal lines SL1-SL6, and the scan start signal line SL8, the operation of the stage SR1-SRn, and the arrangement of the signal lines is substantially similar to the description of FIGS. 1 to 5, and therefore will be omitted.

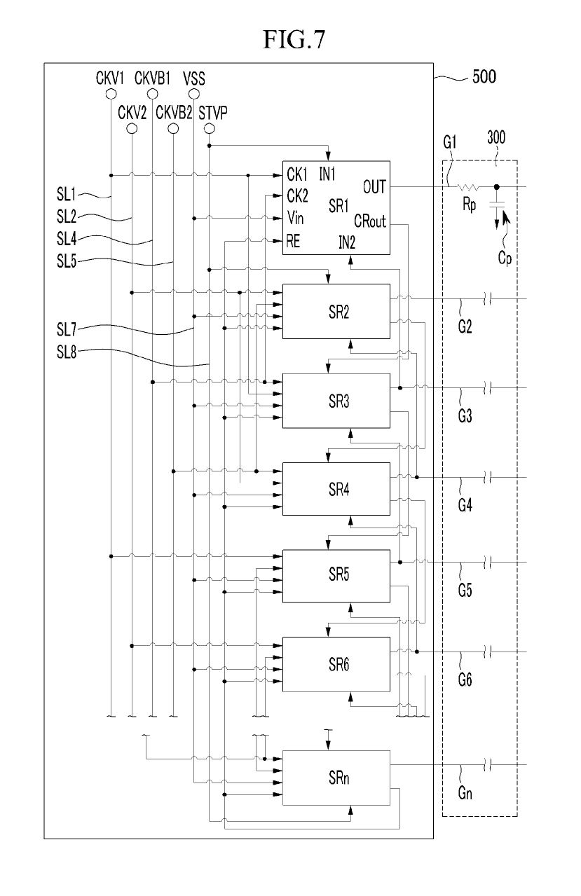

Next, another exemplary embodiment of a gate driver and a gate line of another exemplary embodiment of a display panel according to the present invention will be described with reference to FIG. 7. The repetitive description between the present embodiment and that of FIG. 1 to FIG. 5 is omitted.

FIG. 7 is a block diagram of another exemplary embodiment of a gate driver and a gate line of a display panel according to the present invention.

Referring to FIG. 7, four clock signal lines SL1, SL2, SL4, and SL5 are formed, CKV1 and CKVB1 are clock signals having different phases, respectively, and CKV2 and CKVB2 are clock signals having different phases, respectively. Similar to the description with respect to FIG. 2, the voltage signal line SL7 is disposed between the clock signal lines SL1, SL2, SL4, and SL5 and the stages SR1-SRn. The voltage signal line SL7 includes a branch signal line extending in the approximately row direction, and the voltage Vss is applied to the voltage input terminal Vin of the stages SR1-SRn through the branch signal line. The branch signal line of the voltage signal line SL7 does not overlap the clock signal lines SL1, SL2, SL4, and SL5 in order to prevent formation of an overlapping region between the branch signal line of the voltage signal line SL7 and the clock signal lines SL1-SL6, and thereby the capacitance of the clock signal lines SL1, SL2, SL4, and SL5 may be reduced and the RC delay may be reduced.

Contrarily, if the clock signal lines SL1, SL2, SL4, and SL5 are disposed between the voltage signal line SL7 and the stages SR1-SRn, when the voltage Vss is applied to the stages SR1-SRn through the voltage signal line SL7, the voltage signal line SL7 and the clock signal lines SL1, SL2, SL4, and SL5 are insulated from and intersect each other; that is, they cross one another without electrically contacting one another, e.g., in one exemplary embodiment they are disposed substantially perpendicular to each other. Accordingly, the overlapping region between the voltage signal line SL7 and the clock signal lines SL1, SL2, SL4, and SL5 exists, and thereby, in such a comparative embodiment, the capacitance of the clock signal lines SL1, SL2, SL4, and SL5 increases and the RC delay increases.

The connection relationship and the operation of the stages SR1-SRn may be repeated in units equaling a multiple of two or four.

For example, the first input terminal IN1 of the third stage SR3 is connected to the transmitting signal output terminal CRout of the first stage SR1, and the first input terminal IN1 of the fourth stage SR4 is connected to the transmitting signal output terminal CRout of the second stage SR2. The first input terminal IN1 of the first stage SR1 and the second stage SR2 are applied with the scan start signal STVP.

Also, the second input terminal IN2 of the first stage SR1 is connected to the output terminal OUT of the third stage SR3, and the second input terminal IN2 of the second stage SR2 is connected to the output terminal OUT of the fourth stage SR4.

The clock signal lines SL1-SL6 are sequentially connected from the first stage SR1 to the first clock terminal CK1 of the fourth stage SR4, and are again sequentially connected from the fifth stage SR5 to the eighth stage SR8, and this connection relationship is repeated.

Also, the second clock terminal CK2 of the first stage SR1 is applied with the clock signal CKVB1 having a different phase from the clock signal CKV1, the second clock terminal CK2 of the second stage SR2 is applied with the clock signal CKVB2 having a different phase from the clock signal CKV2, the second clock terminal CK2 of the third stage SR3 is applied with the clock signal CKV1 having a different phase from the clock signal CKVB1, and the second clock terminal CK2 of the fourth stage SR4 is applied with the clock signal CKV2 having a different phase from the clock signal CKVB2.

The operation of the stages SR1-SRn and the arrangement of the signal lines is substantially similar to that described above with respect to FIG. 3 to FIG. 5.

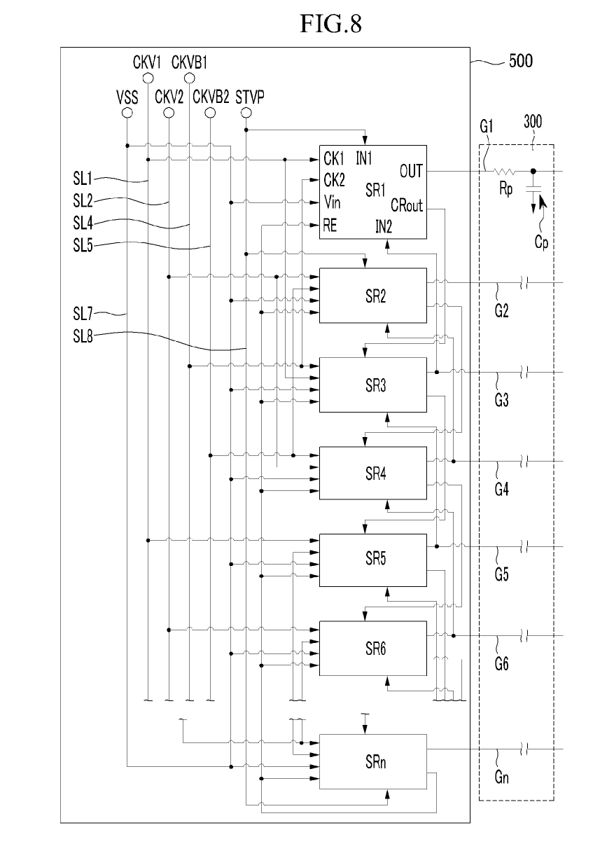

Next, another exemplary embodiment of a gate driver and a gate line of a display panel according to the present invention will be described with reference to FIG. 8. The repetitive description between that of FIG. 7 is omitted.

FIG. 8 is a block diagram of an exemplary embodiment of a gate driver and a gate line of a display panel according to the present invention.

The voltage signal line SL7 is an approximately rectangular, and includes two lines extending in the approximate column direction and two lines extending in the approximate row direction. In the present exemplary embodiment, the line disposed on the upper side among two lines extending in the row direction may be omitted. Two lines extending in the column direction are disposed between the clock signal lines SL1, SL2, SL4, and SL5 and the scan start signal line SL8, and outside the clock signal lines SL1, SL2, SL4, and SL5.

Similar to the description of FIG. 2, the branch signal line connected to the voltage input terminal Vin of each stage SR1-SRn extend in the approximate row direction, and are directly connected to the voltage signal line SL7 positioned between the clock signal line SL1, SL2, SL4, and SL5 and the scan start signal line SL8. Accordingly, the branch signal line of the voltage signal line SL7 does not overlap the clock signal lines SL1, SL2, SL4, and SL5 such that the overlapping between the branch signal line of the voltage signal line SL7 and the clock signal lines SL1, SL2, SL4, and SL5 is prevented, and thereby the capacitance of the clock signal lines SL1, SL2, SL4, and SL5 may be reduced and the RC delay may be reduced.

The connection relationship of the stages SR1-SRn, the clock signal lines SL1, SL2, SL4, and SL5, and the scan start signal line SL8, and the operation of the stages SR1-SRn, is substantially similar to that described above with respect to FIG. 7.

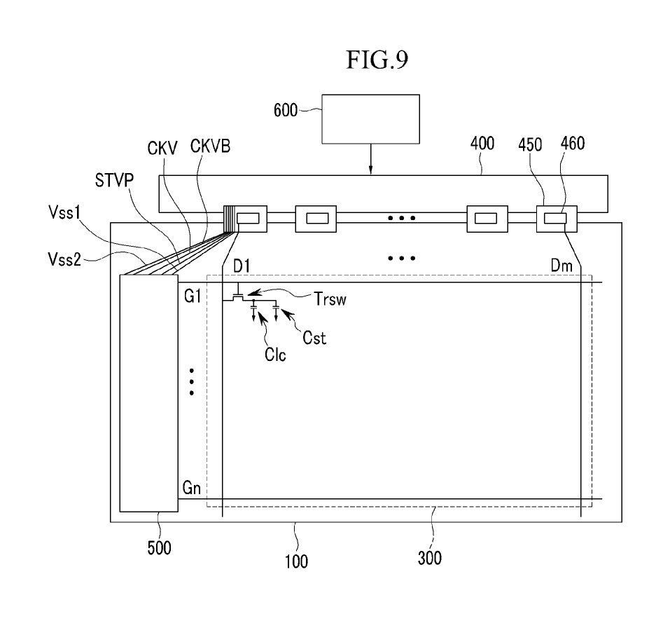

Next, another exemplary embodiment of a display panel according to the present invention will be described with reference to FIG. 9 to FIG. 14. The repetitive description between the present embodiment and that of FIG. 1 to FIG. 5 is omitted.

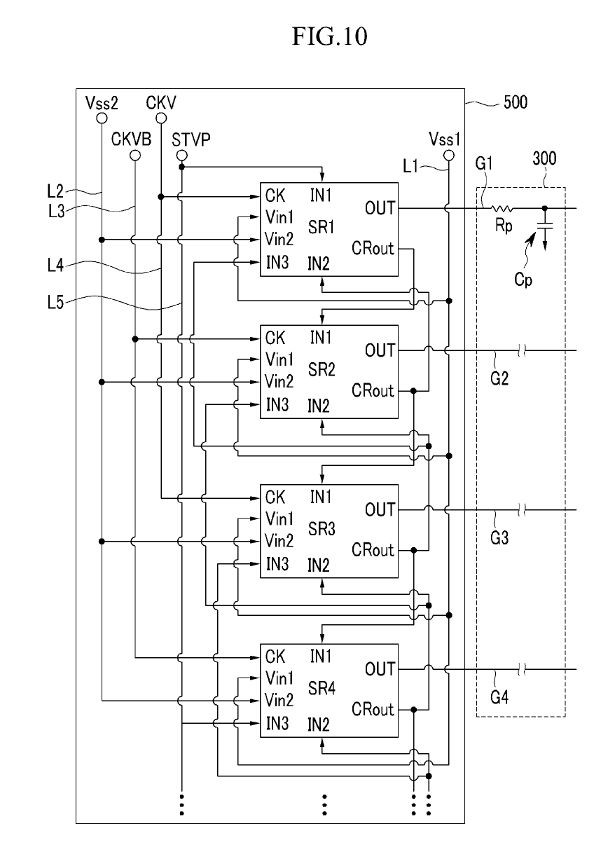

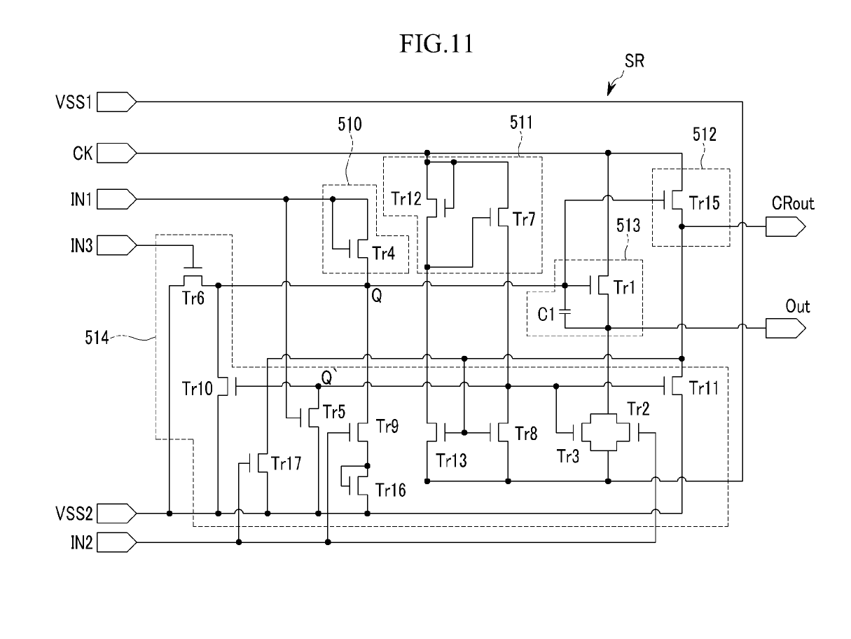

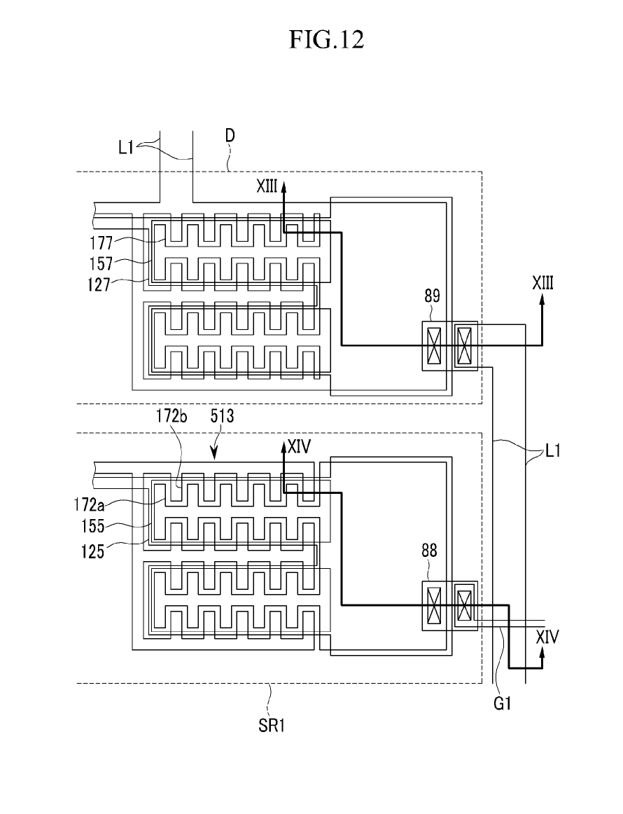

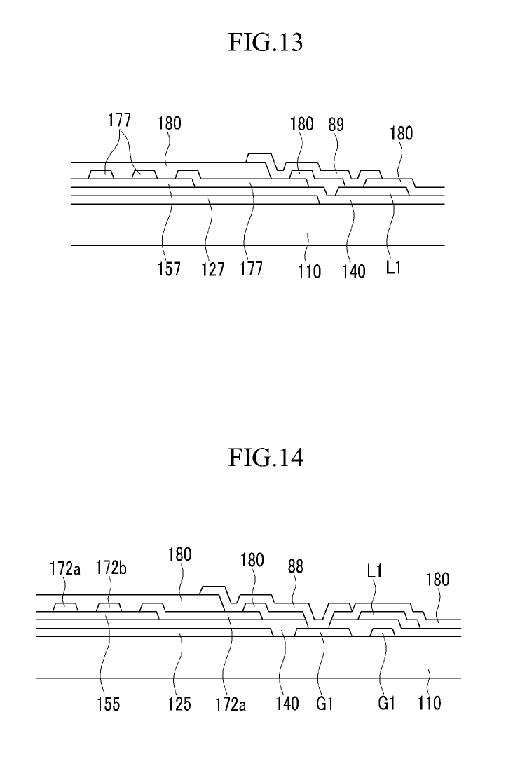

FIG. 9 is a top plan view of another exemplary embodiment of a display panel according to the present invention, FIG. 10 is a block diagram showing an exemplary embodiment of a gate driver and a gate line in the display panel shown in FIG. 9, FIG. 11 is a circuit diagram showing an exemplary embodiment of one stage shown in FIG. 10, FIG. 12 is a top plan view showing an exemplary embodiment of a dummy stage and a first stage, FIG. 13 is a cross-sectional view taken along line XIII-XIII of FIG. 12, and FIG. 14 is a cross-sectional view taken along line XIV-XIV of FIG. 12.

Referring to FIG. 9, the signal provided from the signal controller 600 includes a signal such as clock signals CKV and CKVB, the scan start signal STVP, and the signal providing low voltages Vss1 and Vss2 having a special voltage level.

The gate driver 500 receives the clock signals CKV and CKVB, the scan start signal STVP, the first low voltage Vss1 conforming to the gate-off voltage, and the second low voltage Vss2 that is less than, e.g., lower in magnitude than, the gate-off voltage to generate the gate voltages (the gate-on voltage and the gate-off voltage) and to sequentially apply the gate-on voltage to the gate lines G1-Gn.

The first low voltage Vss1 and the second low voltage Vss2, the clock signals CKVB and CKV, and the scan start signal STVP that are applied to the gate driver 500 are transmitted through the first voltage signal line L1, the second voltage signal line L2, the clock signal lines L3 and L4, and the scan start signal line L5.

Referring to FIG. 10, the display area 300 is represented by the resistor Rp and the capacitor Cp. As shown in FIG. 10, the gate lines G1-Gn, and the liquid crystal capacitor Clc and the storage capacitor Cst, respectively have the resistance and the capacitance, and the sum thereof is represented by one resistor Rp and one capacitor Cp. The gate voltage output from the stage SR is transmitted through the gate line. The gate lines G1-Gn are presented to have the resistance Rp and the capacitance Cp as seen from the circuit view. These values represent an entire value for the gate lines G1-Gn, and may be changed according to the structure and the characteristics of the display area 300.

The gate driver 500 includes a plurality of stages SR1, SR2, SR3, and SR4 that are dependently connected to each other. Each of the stages SR1, SR2, SR3, SR4, . . . includes three input terminals IN1, IN2, and IN3, one clock input terminal CK, two voltage input terminals Vin1 and Vin2, a gate voltage output terminal OUT outputting the gate voltage, and a transmission signal output terminal CRout.

Firstly, the first input terminal IN1 is connected to the transmission signal output terminal CRout of the previous stage and thereby receives the transmission signal CR output from the previous stage. However, since the first stage does not have a previous stage, the scan start signal STVP is applied to the first input terminal IN1.

The second input terminal IN2 is connected to the transmission signal output terminal CRout of a subsequent stage, thereby and thereby receives the transmission signal CR therefrom. Also, the third input terminal IN3 is connected to the transmission signal output terminal CRout of the second subsequent stage, and thereby receives the transmission signal CR of the second subsequent stage.

A stage SRn (not shown) connected to the n-th gate line Gn may have two dummy stages to receive the transmission signal CR from the subsequent stage and the second subsequent stage. The dummy stages SRn+1 and SRn+2 (not shown) are stages that generate and output a dummy gate voltage, which is different from the different stages SR1-SRn. That is, the gate voltage output from the stages SR1-SRn is transmitted through the gate lines such that the data voltage is applied to the pixel for the display of the images, however the dummy stages SRn+1 and SRn+2 may not be connected to the gate lines, although when they are connected to the gate lines, e.g., in order to make the resistances thereof similar to the non-dummy gate lines, they are connected to the gate lines of a dummy pixel (not shown) that do not display the image such that they may not be used for the display of the image.

The clock terminals CK are applied with a clock signal, and among the plurality of stages, the clock terminals CK of the odd-numbered stages are applied with the first clock signal CKV and the clock terminals CK of the even-numbered stages are applied with the second clock signal CKVB. The two clock signals CKV and CKVB are signals having different phases from each other.

The first voltage input terminal Vin1 is applied with the first low voltage Vss1 corresponding to the gate-off voltage, and the second voltage input terminal Vin2 is applied with the second low voltage Vss2 that is lower than, e.g., has a smaller magnitude than, the first low voltage Vss1. The voltage values of the first low voltage Vss1 and the second low voltage Vss2 may be varied according to the exemplary embodiment.

Firstly, the first stage SR1 receives the clock signal CKV externally provided through the clock input terminal CK, the scan start signal STVP provided through the first input terminal IN1, the first and second low voltages Vss1 and Vss2 provided through the first and second voltage input terminals Vin1 and Vin2, and the transmission signals CR respectively provided from the second stage SR2 and the third stage SR3 through the second and third input terminals IN2 and IN3, such that the gate-on voltage is output to the first gate line G1 through the gate voltage output terminal OUT. Also, the transmission signal output terminal CRout outputs the transmission signal CR, and it is transmitted to the first input terminal IN1 of the second stage SR2.

The second stage SR2 receives the second clock signal CKVB externally provided through the clock input terminal CK, the transmission signal CR of the first stage SR1 provided through the first input terminal IN1, the first and second low voltages Vss1 and Vss2 provided through the first and second voltage input terminals Vin1 and Vin2, and the transmission signals CR respectively provided from the third stage SR3 and the fourth stage SR4 provided through the second and third input terminals IN2 and IN3, such that the gate-on voltage is output to the second gate line through the gate voltage output terminal OUT. Also, the transmission signal CR is output through the transmission signal output terminal CRout, thereby being transmitted to the first input terminal IN1 of the third stage SR3 and the second input terminal IN2 of the first stage SR1.

The third stage SR3 receives the clock signal CKV externally provided through the clock input terminal CK, the transmission signal CR of the second stage SR2 provided through the first input terminal IN1, the first and second low voltages Vss1 and Vss2 provided through the first and second voltage input terminals Vin1 and Vin2, and the transmission signals CR respectively provided from the fourth stage SR4 and the fifth stage SR5 provided through the second and third input terminals IN2 and IN3, such that the gate-on voltage is output to the third gate line through the gate voltage output terminal OUT. Also, the transmission signal CR is output through the transmission signal output terminal CRout, thereby being transmitted to the first input terminal IN1 of the fourth stage SR4, the third input terminal IN3 of the first stage SR1, and the second input terminal IN2 of the second stage SR2.

Through the above method, the n-th stage SRn receives the second clock signal CKVB externally provided through the clock input terminal CK, the transmission signal CR of the (n−1)-th stage SR2 provided through the first input terminal IN1, the first and second low voltages Vss1 and Vss2 provided through the first and second voltage input terminals Vin1 and Vin2, and the transmission signals CR respectively provided from the (n+1)-th stage SRn+1 (the dummy stage) and the (n+2)-th stage SRn+2 (the second dummy stage) through the second and third input terminals IN2 and IN3, such that the gate-on voltage is output to the n-th gate line through the gate voltage output terminal OUT. Also, the transmission signal CR is output through the transmission signal output terminal CRout, thereby being transmitted to the first input terminal IN1 of the (n+1)-th stage SRn+1 (the dummy stage), the third input terminal IN3 of the (n−2)-th stage SRn-2, and the second input terminal IN2 of the (n−1)-th stage SRn−1.

Referring to FIG. 11, each stage SR of the gate driver 500 according to the present exemplary embodiment includes an input unit 510, a pull-up driver 511, a transmission signal generator 511, an output unit 512, and a pull-down driver 513.

The input unit 510 includes one transistor (a fourth transistor Tr4), the input terminal and the control terminal of the fourth transistor Tr4 are commonly connected (diode-connected) to the first input terminal IN1, and the output terminal thereof is connected to a node Q. The input unit 511 functions to transmit the high voltage to the node Q when the first input terminal IN1 is applied with a high voltage.

The pull-up driver 511 includes two transistors (a seventh transistor Tr7 and a twelfth transistor Tr12). Firstly, the control terminal and the input terminal of the twelfth transistor Tr12 are diode-connected thereby receiving the clock signals CKV and CKVB through the clock terminal CK, and the output terminal is connected to the control terminal of the seventh transistor Tr7 and the pull-down driver 514. On the other hand, the input terminal of the seventh transistor Tr7 is also connected to the clock terminal CK, and the output terminal is connected to the node Q′ (hereinafter referred to as the second node) and is passed through the node Q′ thereby being connected to the pull-down driver 514. The control terminal of the seventh transistor Tr7 is connected to the output terminal of the twelfth transistor Tr12 and the pull-down driver 514. Here, a parasitic capacitor (not shown) may be respectively formed between the input terminal and the control terminal, and the control terminal and the output terminal, of the seventh transistor Tr7. If the pull-up driver 511 is applied with the high signal at the clock terminal CK, the high signal is transmitted to the control terminal of the seventh transistor Tr7 and the pull-down driver 514 through the twelfth transistor Tr12. The high signal transmitted to the seventh transistor Tr7 turns on the seventh transistor Tr7, and as a result the high signal applied from the clock terminal CK is applied to the node Q′.

The transmission signal generator 512 includes one transistor (a fifteenth transistor Tr15). The input terminal of the fifteenth transistor Tr15 is connected to the clock terminal CK and thereby receives the first clock signal CKV or the second clock signal CKVB, the control terminal thereof is connected to the output terminal of the input unit 511, that is, the node Q, and the output terminal thereof is connected to the transmission signal output terminal CRout outputting the transmission signal CR. Here, a parasitic capacitor (not shown) may be formed between the control terminal and the output terminal. The output terminal of the fifteenth transistor Tr15 is connected to the pull-down driver 514 as well as the transmission signal output terminal CRout, thereby receiving the second low voltage Vss2. As a result, the voltage value when the transmission signal CR is low is the second low voltage Vss2.

The output unit 513 includes one transistor (a first transistor Tr1) and one capacitor (a first capacitor C1). The control terminal of the first transistor Tr1 is connected to the node Q, the input terminal thereof receives the first clock signal CKV or the second clock signal CKVB through the clock terminal CK, the first capacitor C1 is formed between the control terminal and the output terminal, and the output terminal thereof is connected to the gate voltage output terminal OUT. Also, the output terminal is connected to the pull-down driver 514 thereby receiving the first low voltage Vss1. As a result, the value of the voltage of the gate-off voltage is the first low voltage Vss1. This output unit 513 outputs the gate voltage according to the voltage of the node Q and the first clock signal CKV.

The pull-down driver 514 removes charges remaining at the stage SR in order to smoothly output the gate-off voltage and the low voltage of the transmission signal CR, thereby executing functions of decreasing the potential of the node Q, the potential of the node Q′, the voltage output to the transmission signal CR, and the voltage output to the gate line. The pull-down driver 514 include eleven transistors (a second transistor Tr2, a third transistor Tr3, a fifth transistor Tr5, a sixth transistor Tr6, an eighth transistor Tr8 to an eleventh transistor Tr11, a thirteenth transistor Tr13, the sixteenth transistor Tr16, and the seventeenth transistor Tr17).

Firstly, the transistors pulling down the node Q will be described. The transistors pulling down the node Q are the sixth transistor Tr6, the ninth transistor Tr9, the tenth transistor Tr10, and the sixteenth transistor Tr16.

The control terminal of the sixth transistor Tr6 is connected to the third input terminal IN3, the output terminal thereof is connected to the second voltage input terminal Vin2, and the input terminal thereof is connected to the node Q. Therefore, the sixth transistor Tr6 is turned on according to the transmission signal CR applied from the second subsequent stage, thereby having the function of decreasing the voltage of the node Q to the second low voltage Vss2.

The ninth transistor Tr9 and the sixteenth transistor Tr16 are operated together thereby pulling down the node Q, the control terminal of the ninth transistor Tr9 is connected to the second input terminal IN2, the input terminal thereof is connected to the node Q and the output terminal thereof is connected to the input terminal and the control terminal of the sixteenth transistor Tr16. The control terminal and the input terminal of the sixteenth transistor Tr16 are diode-connected to the output terminal of the ninth transistor Tr9, and the output terminal thereof is connected to the second voltage input terminal Vin2. Therefore, the ninth transistor Tr9 and the sixteenth transistor Tr16 are turned on according to the transmission signal CR applied from the subsequent stage, thereby executing the function of decreasing the voltage of the node Q to the second low voltage Vss2.

The input terminal of the tenth transistor Tr10 is connected to the node Q, the output terminal thereof is connected to the second voltage input terminal Vin2, and the control terminal thereof is connected to the node Q′ (and has the reverse voltage to the node Q e.g., a low voltage when the voltage at node Q is a high voltage, such that it is referred to as a reverse terminal). Therefore, the tenth transistor Tr10 functions to continuously decrease the voltage of the node Q to the second low voltage Vss2 in the general period when the node Q′ has the high voltage and then does not decrease the voltage of the node Q when the voltage of the node Q′ is only at the low voltage. When the voltage of the node Q is not decreased, the corresponding stage outputs the gate-on voltage and the transmission signal CR.

The transistors pulling down the node Q′ in the pull-down driver 514 will now be described in more detail. The transistors pulling down the node Q′ are the fifth transistor Tr5, the eighth transistor Tr8, and the thirteenth transistor Tr13.

The control terminal of the fifth transistor Tr5 is connected to the first input terminal IN1, the input terminal thereof is connected to the node Q′, and the output terminal thereof is connected to the second voltage input terminal Vin2. As a result, the fifth transistor Tr5 decreases the voltage of the node Q′ to the second low voltage Vss2 according to the transmission signal CR of the previous stage.

The eighth transistor Tr8 has a control terminal thereof connected to the transmission signal output terminal CRout of the corresponding stage, an input terminal connected to the node Q′, and an output terminal connected to the second voltage input terminal Vin2. As a result, the eighth transistor Tr8 functions to decrease the voltage of the node Q′ to the first low voltage Vss1 according to the transmission signal CR of the corresponding stage.

The thirteenth transistor Tr13 has a control terminal connected to the transmission signal output terminal CRout of the corresponding stage, an input terminal connected to the output terminal of the twelfth transistor Tr12 of the pull-up driver 511, and an output terminal connected to the first voltage input terminal Vin1. As a result, the thirteenth transistor Tr13 functions to decrease the inner potential of the pull-up driver 511 to the first low voltage Vss1 and decrease the voltage of the node Q′ connected to the pull-up driver 511 to the first low voltage Vss1 according to the transmission signal CR of the corresponding stage. That is, the thirteenth transistor Tr13 functions to discharge the inner charges of the pull-up driver 511 to the first low voltage Vss1, however the pull-up driver 511 is also connected to the node Q′ in order for the voltage of the node Q′ to not be pulled up such that the thirteenth transistor Tr13 assists to decrease the voltage of the node Q′ to the second low voltage Vss2.

The transistors which decrease the voltage output to the transmission signal CR in the pull-down driver 514 will now be described in more detail. The transistors decreasing the voltage output to the transmission signal CR are the eleventh transistor Tr11 and the seventeenth transistor Tr17.

The eleventh transistor Tr11 has a control terminal connected to the node Q′, an input terminal connected to the transmission signal output terminal CRout, and a output terminal connected to the second voltage input terminal Vin2. As a result, when the voltage of the node Q′ is high, the voltage of the transmission signal output terminal CRout is decreased to the second low voltage Vss2 such that the transmission signal CR is changed into the low level.

The seventeenth transistor Tr17 includes a control terminal connected to the second input terminal IN2, an input terminal connected to the transmitting signal output terminal CRout, and an output terminal connected to the second voltage input terminal Vin2. As a result, the voltage transmitting signal of the output terminal CRout is decreased to the second low voltage Vss2 according to the transmitting signal CR of the next stage. The seventeenth transistor Tr17 is operated based on the transmitting signal CR of the subsequent stage to assist the operation of the eleventh transistor Tr11.

The transistors which decrease the voltage output to the gate line from the pull-down driver 514 will now be described in more detail. The transistors which decrease the voltage output to the gate line are the second transistor Tr2 and the third transistor Tr3.

The second transistor Tr2 has a control terminal connected to the second input terminal IN2, an input terminal connected to the gate voltage output terminal OUT, and an output terminal connected to the first voltage input terminal Vin1. As a result, the gate voltage output when the transmission signal CR of the subsequent stage is output is changed to the first low voltage Vss1.

The third transistor Tr3 has a control terminal connected to the node Q′, an input terminal connected to the gate voltage output terminal OUT, and an output terminal connected to the first voltage input terminal Vin1. As a result, the gate voltage output when the voltage of the node Q′ is high is changed to the first low voltage Vss1.

In the pull-down driver 514, the operations for decreasing the voltage output to the transmitting signal CR and the voltage output to the gate line are respectively executed through two transistors that are connected to the second input terminal IN2, thereby being operated according to the transmitting signal CR of the subsequent stage or the voltage of the Q′ node with substantially the same timing. However, the voltage output to the transmitting signal CR is decreased to the second low voltage Vss2 and the gate-off voltage is decreased to the first low voltage Vss1 such that the voltage when the transmitting signal CR is low is less than the gate-off voltage.

In the pull-down driver 514, the gate voltage output terminal OUT is only decreased to the first low voltage Vss1, and the node Q and the transmission signal output terminal CRout are decreased to the second low voltage Vss2 that is lower in magnitude than the first low voltage Vss1. As a result, although the gate-on voltage and the high voltage of the transmission signal CR may be substantially the same voltage, the gate-off voltage and the low voltage of the transmission signal CR are different voltages. That is, the gate-off voltage is the first low voltage Vss1, and the low voltage of the transmission signal CR is the second low voltage Vss2. On the other hand, the node Q′ is decreased to the first low voltage Vss1 by the eighth transistor Tr8 and the thirteenth transistor Tr13, and is decreased to the second low voltage Vss2 by the fifth transistor Try.

The gate voltage and transmission signal CR may have various voltage values. For example, in one exemplary embodiment the gate-on voltage may be about 25 V, the gate-off voltage and the first low voltage Vss1 may be about −5 V, the high voltage of the transmission signal CR may be about 25 V, and the low voltage and the second low voltage Vss2 may be about −10 V.

In summary, the transmission signal generator 512 and the output unit 513 are operated by the voltage of the node Q such that one stage SR outputs the high voltage of the transmission signal CR and the gate-on voltage, the transmission signal CR is decreased from the high voltage to the second low voltage Vss2 by the previous stage, the subsequent stage, and the second next transmission signals CR, and the gate-on voltage is decreased to the first low voltage Vss1 thereby being the gate-off voltage. Here, one stage SR decreases the voltage of the node Q to the second low voltage Vss2 by the second next transmission signal CR as well as the subsequent transmission signal CR to reduce the power consumption, and the second low voltage Vss2 is lower than the first low voltage Vss1 as the gate-off voltage such that the second low voltage Vss2 is sufficiently low such that the transistors included in the stage flow the leakage current or not, and thereby the power consumption may be decreased even though the transmission signal CR applied in the different stage includes a ripple or a noise, such that the voltage is changed.

Referring to FIG. 12 and FIG. 13, the first voltage signal line L1 is insulated from and intersects the gate line G1 connected to the first stage SR1, that is, they cross one another without electrically contacting one another, e.g., in one exemplary embodiment they are disposed substantially perpendicular to each other. When the static electricity is inflowed in the first voltage signal line L1, to prevent the gate lines G1-Gn from being damaged, the first voltage signal line L1 is disposed to be electrically connected to the dummy stage D. For example, the first voltage signal line L1 may be formed at the same layer, e.g., at a same height above a substrate, as the data lines D1-Dm, and may include substantially the same material, e.g., may be formed from a same metal layer. Also, the first voltage signal line L1 is connected to the source electrode or the drain electrode of at least one of the transistors positioned in the dummy stage D, and is also shorted to the source electrode and the drain electrode of the corresponding transistor such that it is formed of one first metal pattern 177. Accordingly, before the first low voltage Vss1 is passed on the gate line G1 of the first stage SR1 according to the first voltage signal line L1, the first low voltage Vss1 is passed through the transistor or the capacitor of the dummy stage D such that the static electricity may be reduced, and thereby the gate line G1 may be prevented from being damaged by the static electricity. The first metal pattern 177 of the dummy stage D may be positioned at the same layer, e.g., at a same height above a substrate, as the data lines D1-Dm, and may include substantially the same material, e.g., may be formed from a same metal layer.

Also, the first metal pattern 177 of the dummy stage D and the first voltage signal line L1 are connected through a connecting member 89. The connecting member 89 may be positioned at the same layer as a pixel electrode (not shown) and may include the same material. As a result, the first voltage signal line L1 is temporarily isolated before forming the pixel electrode such that the static electricity may be passed on the gate line G1 even though the static electricity may be generated in the first voltage signal line L1 before the formation of the pixel electrode in the manufacturing process of the display panel.

A gate electrode 125 of the first transistor Tr1 and a second metal pattern 127 are positioned on the substrate 110. The gate electrode 125 and the second metal pattern 127 may be positioned at the same layer, e.g., disposed a same distance from a substrate, as the gate lines G1-Gn and may include the same material, e.g., may be formed from a same metal layer.

A gate insulating layer 140 such as SiNx or SiOx is formed on the gate electrode 125 and the second metal pattern 127.

A semiconductor 155 of the first transistor Tr1 and a semiconductor pattern 157 of the dummy stage D are positioned on the gate insulating layer 140.

A source electrode 172b of the first transistor Tr1, a drain electrode 172a of the first transistor Tr1, and the first metal pattern 177 are disposed on the semiconductor 155 of the first transistor Tr1 and the semiconductor pattern 157 of the dummy stage D. The source electrode 172b of the first transistor Tr1, the drain electrode 172a of the first transistor Tr1, and the first metal pattern 177 may be made from the same layer as the data lines D1-Dm, and may include the same material, e.g., they made be patterned from a common metal layer.

A passivation layer 180 is formed on the source electrode 172b of the first transistor Tr1, the drain electrode 172a of the first transistor Tr1, and the first metal pattern 177. In one exemplary embodiment, the passivation layer 180 may include the inorganic insulating material and the organic insulating material.

Connecting members 88 and 89 are formed on the passivation layer 180. In the case of the first stage SR1, the drain electrode 172a of the first transistor is connected to the gate line G1 through the connecting member 88. In the case of the dummy stage D, the first metal pattern 177 is connected to the first voltage signal line L1 through the connecting member 89.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display panel comprising:
a substrate;
a display area comprising a gate line disposed on the substrate; and
a gate driver connected to one end of the gate line, and integrated on the substrate, the gate driver comprising:
a plurality of stages disposed in a first direction,
a plurality of clock signal lines which extend in the first direction; and
a voltage signal line which extends in the first direction, and
wherein the voltage signal line is disposed between the plurality of clock signal lines and the plurality of stages.

2. The display panel of claim 1, wherein the plurality of clock signal lines includes at least four clock signal lines.

3. The display panel of claim 2, wherein the plurality of clock signal lines and the voltage signal line are positioned at a same distance from the substrate.

4. The display panel of claim 1, wherein the voltage signal line comprises an assistance signal line which extends in the first direction outside the plurality of clock signal lines, and wherein the assistance signal line is connected to the voltage signal line.

5. The display panel of claim 4, wherein the plurality of clock signal lines includes at least four clock signal lines.

6. The display panel of claim 1, wherein the voltage signal line comprises a branch signal line connected to a voltage input terminal of a stage of the plurality of stages.

7. The display panel of claim 6, wherein the branch signal line is disposed at a different distance from the substrate than the plurality of clock signal lines and the voltage signal line.

8. The display panel of claim 7, wherein the plurality of clock signal lines and the voltage signal line are disposed at a same distance from the substrate.

9. The display panel of claim 6, wherein two of the plurality of clock signal lines are respectively connected to a first clock input terminal of the stage and a second clock input terminal of the stage.

10. The display panel of claim 9, wherein each stage of the plurality of stages comprises a first input terminal, a second input terminal, an output terminal, and a transmitting signal output terminal, and
wherein the first input terminal of at least one stage of the plurality of stages is connected to the transmitting signal output terminal of another stage of the plurality of stages, and the output terminal is connected to the second input terminal of another stage of the plurality of stages.

11. The display panel of claim 10, wherein each stage of the plurality of stages comprises an input section, a pull-up driver, a pull-down driver, an output unit, and a transmitting signal generator.

12. The display panel of claim 11, wherein the input section, the pull-down driver, the output unit, and the transmitting signal generator are connected to a first node.

13. A display panel comprising:
a substrate;
a display area comprising a gate line disposed on the substrate; and
a gate driver connected to one end of the gate line, and integrated on the substrate, the gate driver comprising:
a plurality of stages,
a first voltage signal line which applies a first low voltage to a stage of the plurality of stages; and
a second voltage signal line which applies a second low voltage which has a smaller magnitude than the first low voltage to the stage of the plurality of stages, and
wherein the first voltage signal line is disposed between the plurality of stages and the display area, and the first voltage signal line is connected to one stage of the plurality of stages.

14. The display panel of claim 13, wherein a stage of the plurality of stages that is connected to the first voltage signal line is a dummy stage.

15. The display panel of claim 14, wherein the first voltage signal line is connected to a first metal pattern, and the first voltage signal line and the first metal pattern are disposed at a same distance from the substrate.

16. The display panel of claim 15, wherein the first voltage signal line is connected to the first metal pattern through the connecting member, and the connecting member is disposed at a different distance from the substrate than the first voltage signal line.

17. The display panel of claim 13, wherein each the plurality of stages is applied with a clock signal, at least one transmitting signal of previous stage, and at least two transmitting signals of subsequent stages, and outputs a gate voltage having the first low voltage as a gate-off voltage.

18. The display panel of claim 17, wherein the second low voltage is applied when the at least two transmitting signals are at a low state.

19. The display panel of claim 18, wherein each of the plurality of stages comprises an input unit, a pull-up driver, a pull-down driver, an output unit, and a transmitting signal generator.

20. The display panel of claim 19, wherein the input unit, the pull-down driver, the output unit, and the transmitting signal generator are connected to a same first node.
